(19) United States
(12) Patent Application Publication
(10) Pub. No.: US 2016/0253786 A1
(43) Pub. Date: Sep. 1, 2016

(54) Optimization of Multi-Perspective Auto-Stereoscopic 3D Presentations

(71) Applicant: Inderjit Bains, Vancouver (CA)

(72) Inventor: Inderjit Bains, Vancouver (CA)

(21) Appl. No.: 14/244,765

(22) Filed: Apr. 3, 2014

Related U.S. Application Data
(60) Provisional application No. 61/810,731, filed on Apr. 11, 2013.

(51) Int. Cl. G06T 5/00; G06T 7/00; H04N 13/04

(52) U.S. Cl. CPC G06T 5/002; H04N 13/0402; G06T 7/0024

(57) ABSTRACT

The invention allows a 3D effect to be observed on non-3D specific screens by displaying multiple discrete views of a scene in a sinusoidal or triangle camera displacement waveform with a frequency of approximately 3 Hz to 5 Hz. The invention improves on the current method of using only two views, which results in a jarring experience, and provides methods and formulas to optimize the 3D effect. The invention may be used on computers, kiosks, gaming consoles, laptops, tablets, cell phones, televisions, gaming devices, internet webpages and websites, projectors (for movies or presentations) or other displays.

### BACKGROUND OF THE INVENTION

When two views of a scene, separated by some distance, are properly aligned and switched back and forth at approximately 3 to 5 Hz (3 to 5 “right” scenes interwoven with 3 to 5 “left” scenes per second), a 3D effect can be observed, even with one eye. The resulting image, video, movie, computer simulation, or game will appear to move or wiggle back and forth, which the brain interprets as a 3D effect. However, using only two views will result in a jarring, course effect. To overcome this limitation, the invention quantifies the use of multiple discrete views of the scene, all from a unique perspective, that are displayed in a camera/viewpoint displacement waveform sequence (e.g. sinusoidal, triangle, etc.) to provide a smoothing effect. In addition, the invention provides scene setup methods as well as methods and equations for camera movement to achieve an optimal 3D effect, rather than using empirical trial-and-error.

### BRIEF SUMMARY OF THE INVENTION

The invention presents methods and equations to optimize the effectiveness of auto-stereoscopic 3D presentations which can be viewed on screens or displays not equipped for traditional 3D techniques (3D-specific screens or displays use passive or active glasses or present two views at specific angles/distances from the viewing screen). The 3D effect is instead obtained by moving the camera or viewpoint back and forth at 3 to 5Hz in a defined displacement waveform, which results in a smooth camera movement, as many viewpoints are used (the number of viewpoints depends on the frame rate and switching frequency). Formulas based on the frame rate, switching frequency, and scene dimensions and parameters provide the precise camera movement necessary to see an optimal 3D effect, and remove the empirical guesswork when calculating the camera movement and when moving from one scene to another.

### BRIEF DESCRIPTION OF THE DRAWINGS

FIG. 1 is a top view of horizontal camera displacements which require re-alignment.

FIG. 2 is a top view of arc-centered camera displacements which do not require re-alignment.

FIG. 3 is a two-view square-wave camera displacement in graphical format, 60 frames per second, with 3.75 Hz switching frequency.

FIG. 4 is a multi-view triangle-wave camera displacement in graphical format, 30 frames per second, with 3.75 Hz switching frequency.

FIG. 5 is a multi-view triangle-wave camera displacement in graphical format, 60 frames per second, with 3.75 Hz switching frequency.

FIG. 6 is a general equation for triangle-wave camera displacement.

FIG. 7 Is a multi-view sine-wave camera displacement in graphical format, 60 frames per second, with 3.75 Hz switching frequency.

FIG. 8 is a multi-view sine-wave camera displacement in graphical format, 60 frames per second, with 4 Hz switching frequency.

FIG. 9 is a multi-view sine-wave camera displacement in graphical format, 60 frames per second, with 4.25 Hz switching frequency.

FIG. 10 is a general equation for sine-wave camera displacement.

FIG. 11 is a multi-view sharp-peak camera displacement in graphical format, 60 frames per second, with 3.75 Hz switching frequency.

FIG. 12 is a “critical speed” net camera movement displacement in graphical format, 60 frames per second, with 3.75 Hz switching frequency.

FIG. 13 is a general equation for “critical speed” net camera movement.

FIG. 14 is a top view of scene and camera position dimensions and distances, used to derive the equations for optimal camera displacement amplitude.

FIG. 15 allows the derivations for the camera displacement amplitude equations.

FIG. 16 is a block diagram for live video using multiple cameras.

FIG. 17 is a block diagram for computer generated scenes using virtual cameras and interactive user inputs.

### DETAILED DESCRIPTION OF THE INVENTION

The invention will be described as it applies to its preferred embodiment. It is not intended that the invention be limited as described. Rather, the invention is intended to cover all modifications and alternatives which may be included within the spirit and scope of the invention.

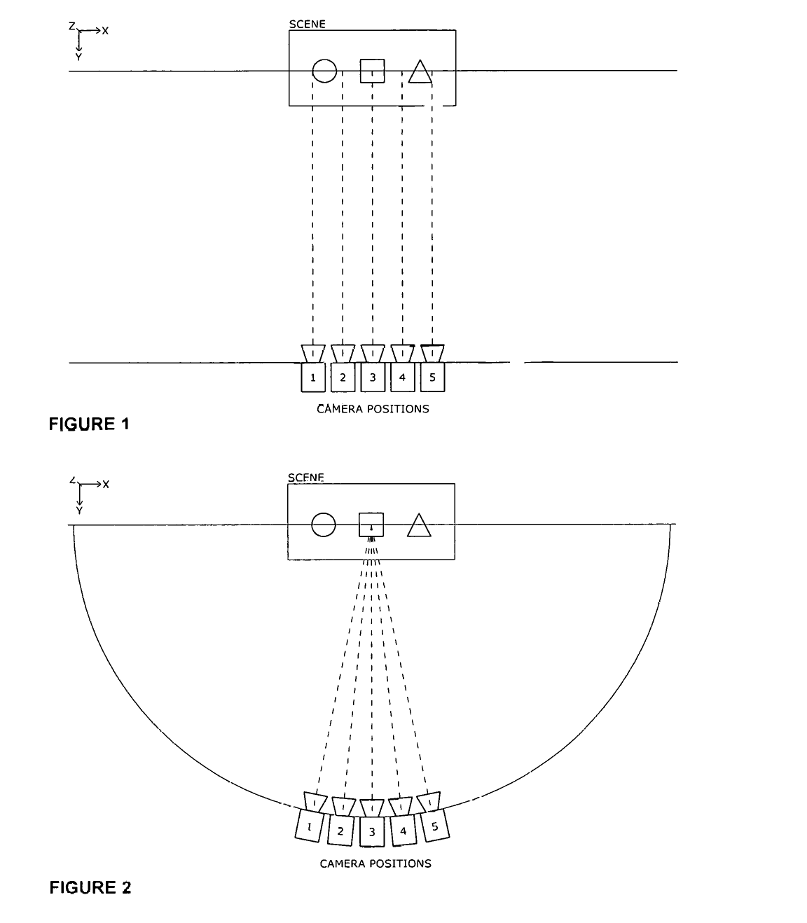

When two views of a scene, taken an appropriate distance apart and appropriately aligned so that they overlap at some point of the scene, and are switched at approximately 3 Hz to 5 Hz, a 3D effect can be observed. Objects in the scene will appear to move back and forth, and the human brain merges the views to create a 3D effect. The two views can be generated by moving the camera (in the real world or in a computer-generated scene) along an axis (e.g. horizontally) and then re-aligning the images (FIG. 1), or by moving the camera in an arc, centered on an object in the scene (FIG. 2). In both FIG. 1 and FIG. 2, the x-y plane is viewed from the top, and the z-axis points up from the page at 90 degrees. In FIG. 1, camera movement occurs along the x-axis. In FIG. 2, camera movement is an arc in the x-y plane centered on an object's z-axis. Multiple frame-synchronized cameras can be used instead of moving one camera, and the output frames selected appropriately in a time sequence. Note that for two views, only Camera Positions 1 and 5 would be used in FIGS. 1 and 2.

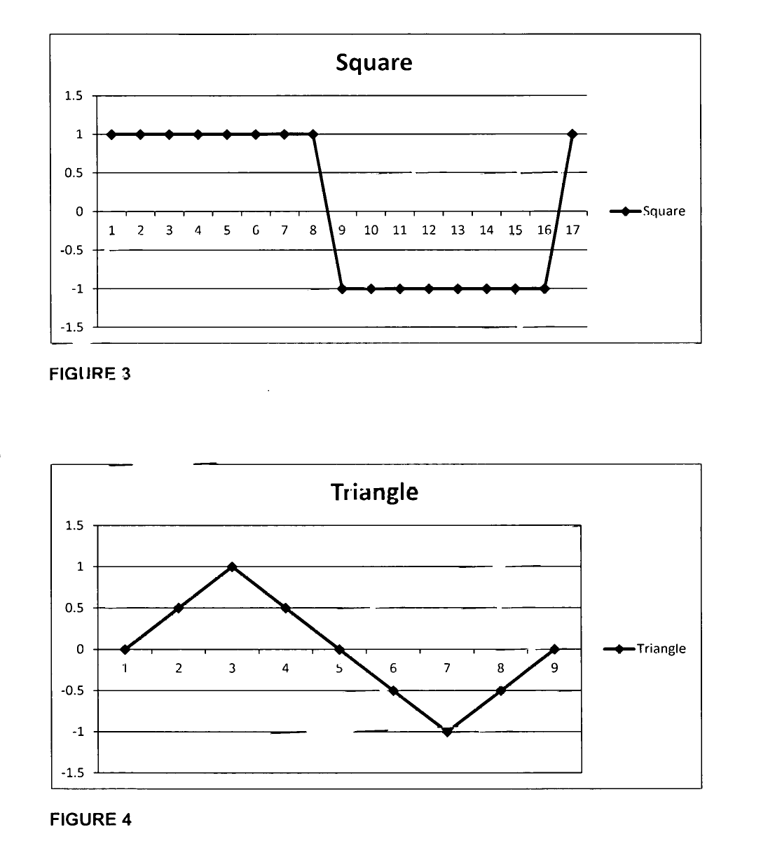

In graphical format, with the frame number on the graph's x-axis and camera displacement on the graph's y-axis (assuming a linear camera movement in time), the resulting camera motion will be a “Square Wave,” if only cameras 1 and 5 are used. At 60 frames per second, a switching rate of 3.75 Hz will provide 16 frames per cycle, or 8 consecutive frames per view. A normalized graph is shown in FIG. 3, with +1 and −1 representing left and right views (cameras 1 and 5), or vice versa (the frame number is shown on the x-axis; the 17^{th} frame is the start of the next cycle).

The effect of using only two views can be a bit jarring. To smooth out the effect, but still allow the 3D effect to be observed, several views of the scene can be used. If all five camera positions in FIG. 1 or FIG. 2 are used with a linear camera movement in time, the camera displacement waveform will be a “Triangle Wave.” A normalized graph is shown in FIG. 4, for 30 frames per second, 3.75 Hz switching frequency. “0” displacement is position 3, “0.5” is position 2, “1” is position 1, “−0.5” is position 4, and “−1” is position 5 (the 9^{th} frame is the start of the next cycle).

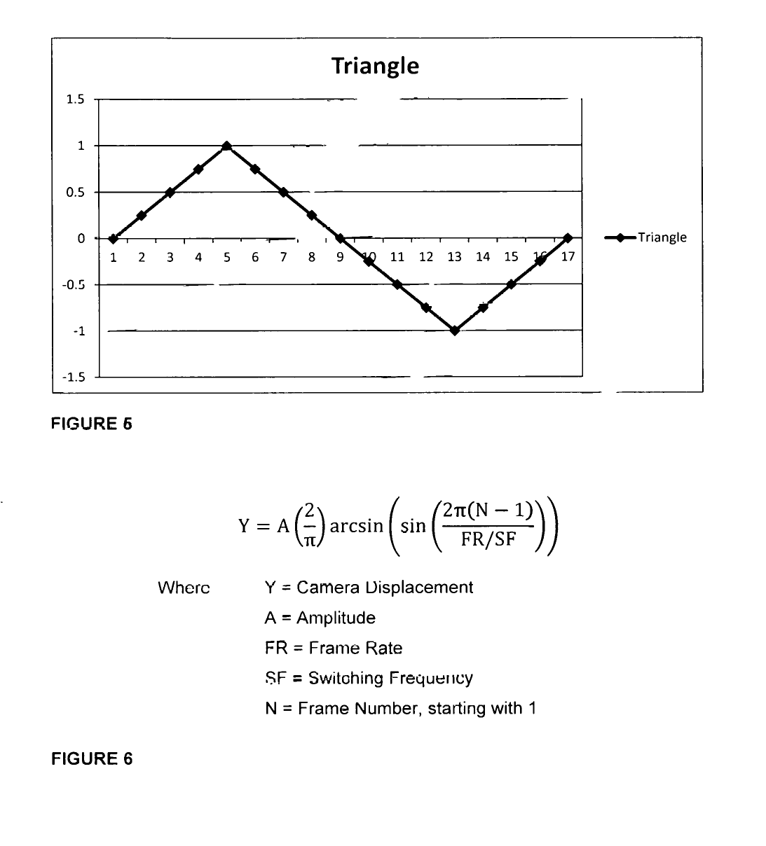

Additional camera positions can be used at higher frame rates to provide more smoothing. A triangle wave camera displacement, with a frame rate of 60 Hz, and with 3.75 Hz switching (total of 9 camera positions) is shown in FIG. 5. A general equation for triangle wave camera displacements is shown in FIG. 6. Note that if the displacement is horizontal and not arc-centered, additional adjustments to properly align the frames will need to be made, usually to keep one object or x-z plane motionless.

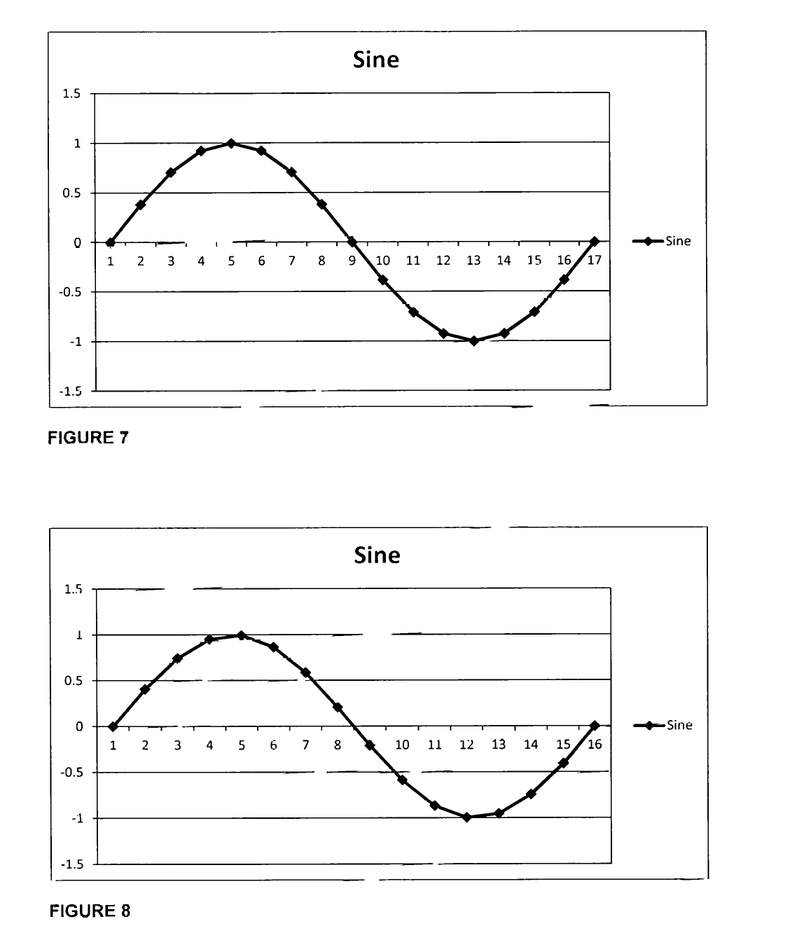

Non-linear camera displacements in time can be used to generate other displacement waveforms. An example is a sinusoidal waveform, shown in FIG. 7. With a frame rate of 60 Hz, 3.75 Hz switching will provide 16 frames per cycle. Each half cycle will have 8 frames, with a deviation from center to the left or right and back to center.

The present invention allows different switching frequencies to be used, other than 3.75 Hz. FIG. 8 shows a switching frequency of 4 Hz with 60 frames per second. Additional example: 48 frames per second, 12 frames per cycle, 4 Hz switching frequency. Note that the camera positions in FIG. 8 are not the same on the rising and falling parts of the curve, and there is no view at the zero crossing in the middle of the waveform. In practice, this does not hinder the 3D effect. There is a zero crossing at the start of each cycle, so the same view displacements will repeat every cycle.

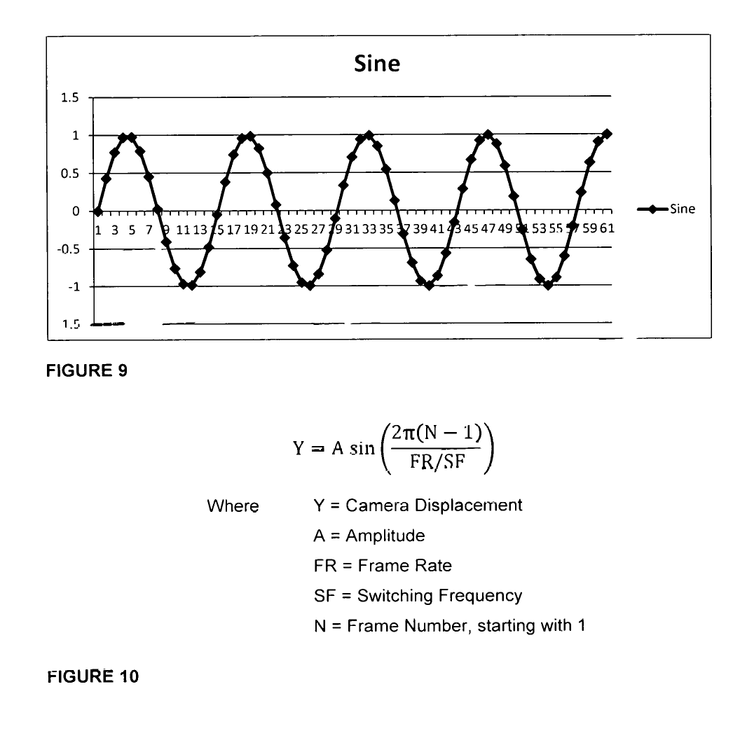

Switching rates from approximately 3 Hz to 5 Hz are optimal. Higher switching rates will cause blurring, and lower rates will produce movement with a diminishing 3D effect. For some switching frequency and frame rate combinations, the view displacements will not repeat for several cycles. An example is 4.25 Hz at 60 frames per second, which will repeat after 240 frames (there is an extra quarter cycle every 60 frames, or exactly one extra cycle after 240 frames). In practice, this does not hinder the 3D effect. The first 60 frames of 4.25 Hz switching, with a frame rate of 60 frames per second, is shown in FIG. 9.

A general equation for sine wave camera displacements is shown in FIG. 10. As with triangle wave displacements, displacements that are not arc-centered will require additional adjustments to properly align the frames.

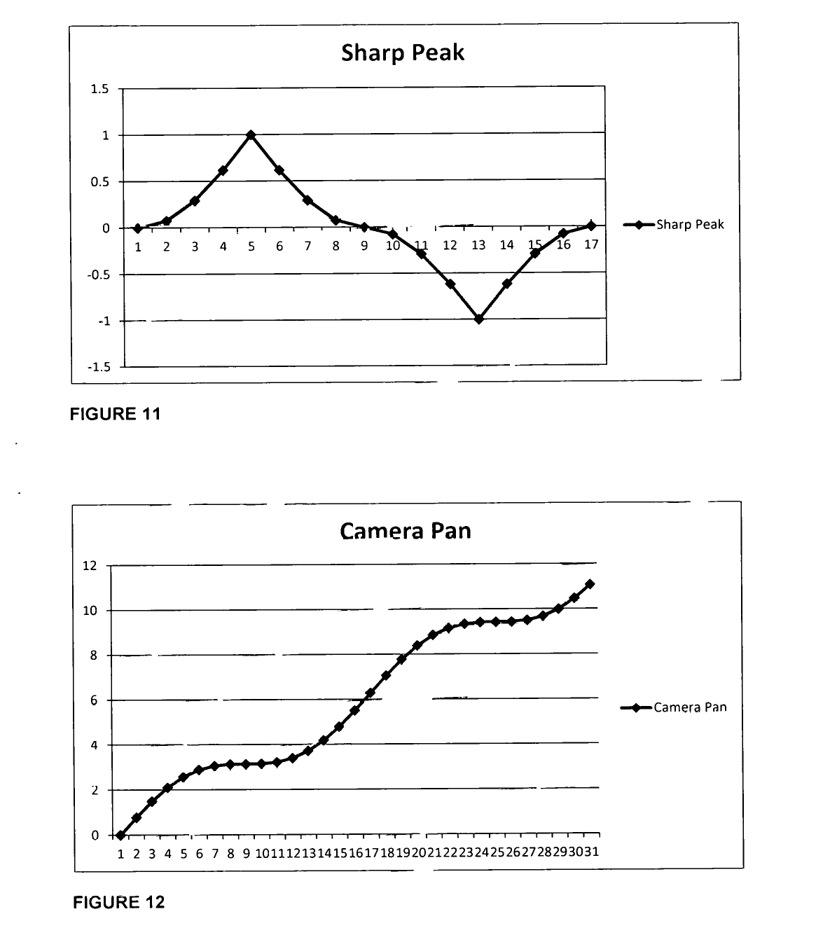

Another waveform that can be used has sharp peaks and slower camera motion around the zero crossing point, as shown in FIG. 11. In practice, the Sine and Triangle waveforms work best, with the Sine waveform producing a more natural motion. The Sharp Peak camera displacement produces an unnatural camera movement and does not produce a good 3D result.

Rapid net camera movements (e.g. camera pan) will disrupt the observed 3D effect. The displacement waveform amplitude can be increased to compensate for the camera movement. Situations that require very fast camera movements may not provide a 3D effect, even with increased amplitude. In this case, it may preferable to turn the 3D effect off until the camera movement has ceased or has slowed down enough to perceive the 3D effect.

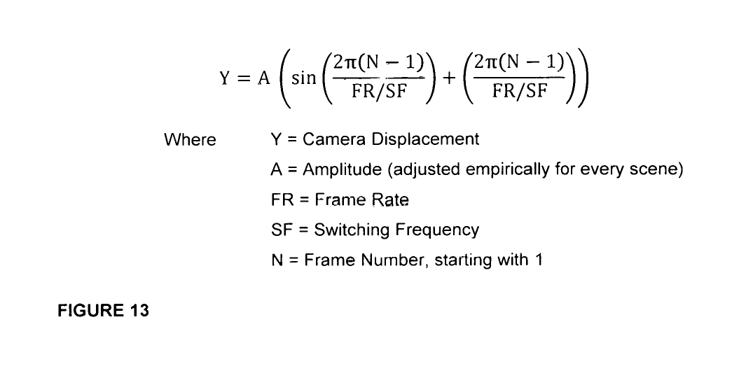

For net camera movements where the displacement is close to the waveform displacement of the 3D effect, a “critical” camera speed can be used to cancel out the 3D movements in one direction, while exaggerating the movement in the opposite direction. An example is shown in FIG. 12, 60 frames per second with a switching rate of 3.75 Hz. If an arc-centered camera movement is used (or a horizontal displacement with image re-alignment), the central object will appear stationary, while the objects in front and behind the center object will move in one direction, stop for a few frames, and then move again. A good 3D effect is achievable using this method, while minimizing the observed back-and-forth movement. A general formula for producing a camera displacement waveform of FIG. 12 is shown in FIG. 13.

For all equations, if the frame rate is evenly divisible by the switching frequency, the calculations can be done for one cycle and then repeated as long as the camera is not required to have a net movement.

The ideal camera displacement amplitude depends on the scene layout and geometry. Too much movement in a scene will be distracting, and too little will result in a reduced 3D effect. Camera displacement amplitude resulting in scene movement for any one object that is ˜0.2% to ˜0.4% of the scene width produces a good 3D result while minimizing movement.

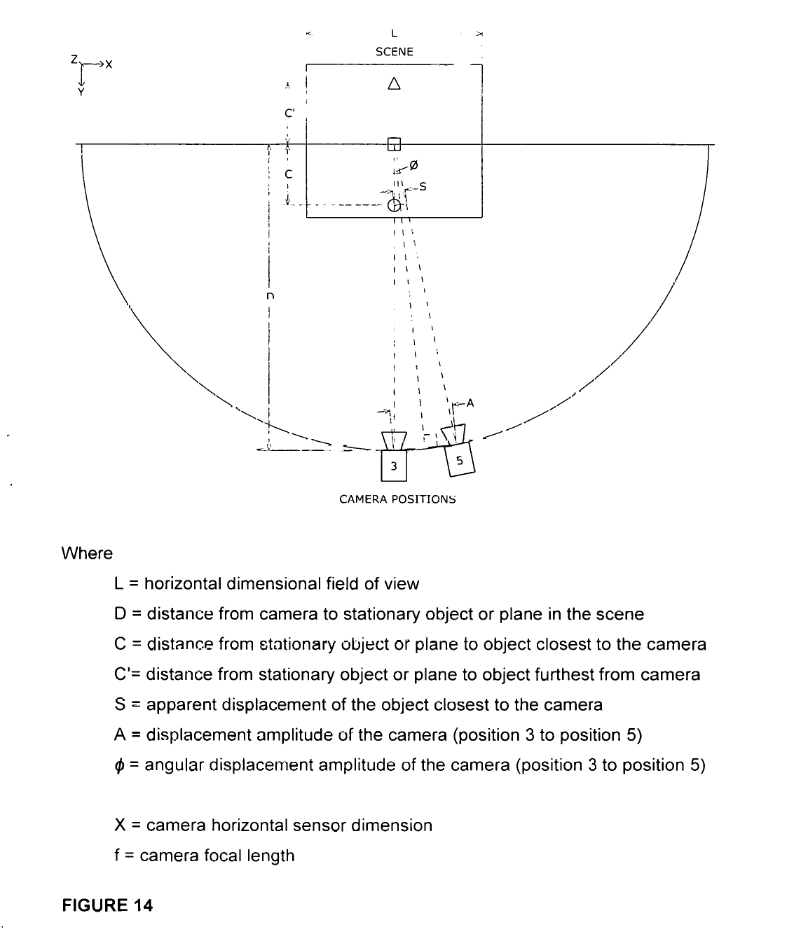

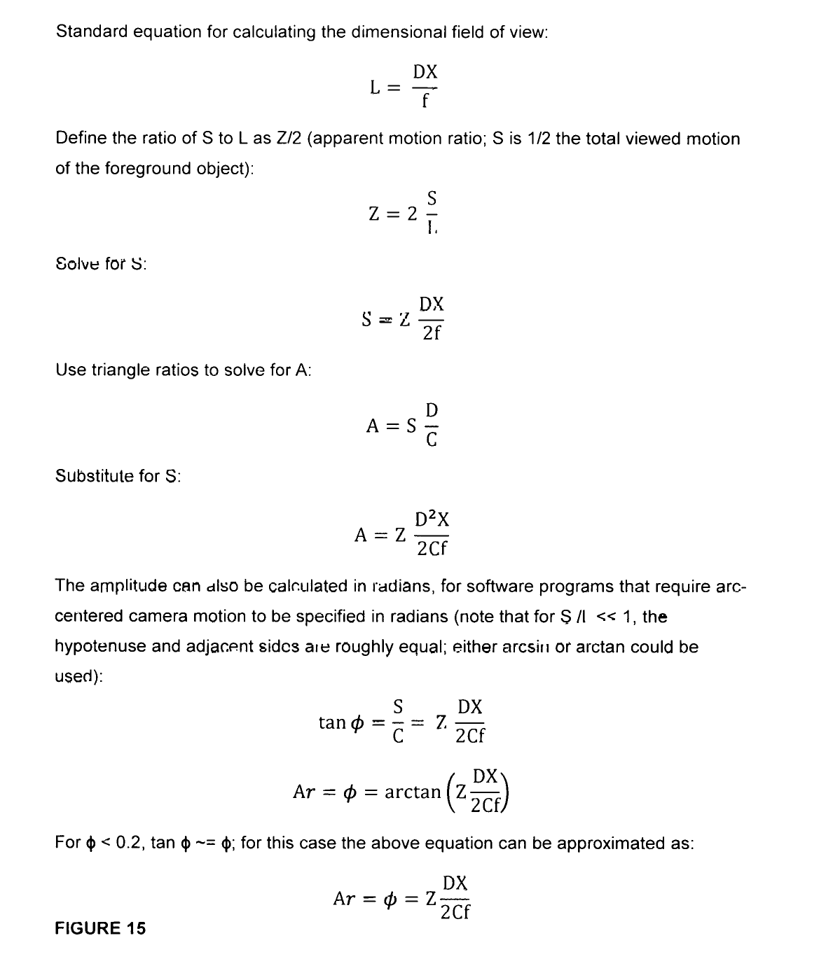

FIG. 14 shows the dimensions of a scene. A derivation for the amplitude of the camera movement for arc-centered camera displacement, “A,” is shown in FIG. 15, with the assumption that objects furthest behind the stationary object or plane are approximately the same distance from the stationary object or plane as the objects closest to the camera: C′˜=C. This will ensure that the background and foreground objects have similar movement. A derivation is also shown for arc-centered angular camera displacement, “φ,” in radians.

Example: 50 mm lens, 35 mm camera (X=36 mm), Z=0.002:

$$A = 0.002 \frac{{D}^{2} ( 36 )}{2 C ( 50 )}$$

$$A = 7.2 \times {10}^{- 4} \frac{{D}^{2}}{C}$$

Angular displacement amplitude in radians:

$$Ar = φ = arctan ( 0.002 \frac{D ( 36 )}{2 C ( 50 )} )$$

$$Ar = φ = arctan ( 7.2 \times {10}^{- 4} \frac{D}{C} )$$

### IMPLEMENTATION

The present invention may be implemented on a computer, kiosk, gaming console, laptop, tablet, smart phone, television, handheld gaming device, projector (for movies or presentations) or similar device.

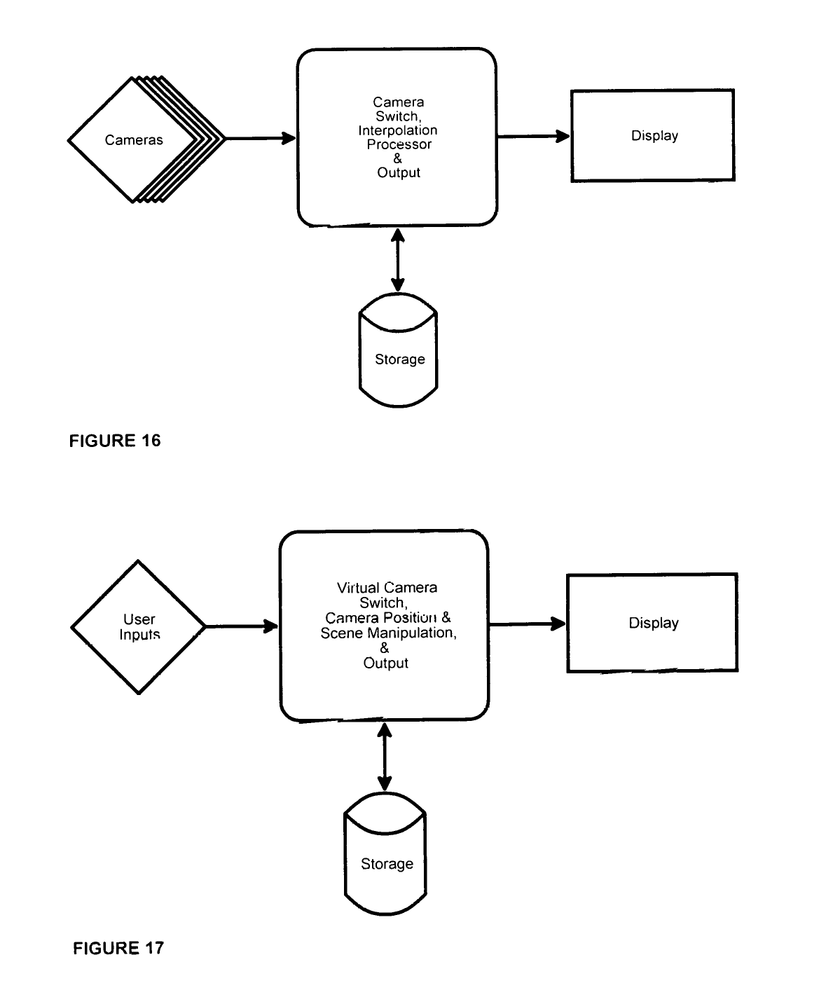

As shown in FIG. 16, live video can be implemented using two cameras (or even one camera), and converted to multi-perspective views with computer interpolation/manipulation algorithms. Live video can also be implemented using multiple cameras, with each camera used to provide a frame in the required sequence to generate a sine or triangle waveform when the camera location is plotted against the frame number. In addition, image rendering software can be used to insert computer-generated images, characters and objects into the video frames, which can be viewed in real-time or stored electronically and viewed at a later time.

For games and other computer-generated applications, multi-perspective views can be generated directly from the available scene data (as show in FIG. 17), either by moving the virtual camera along an axis and then re-aligning each image, or by moving the camera in an arc on a plane centered on an object in the scene. As with live video, the output sequence can be viewed in real-time it the computer's real-time rendering capability can provide 24 frames per second or more, or the output can be stored electronically and viewed at a later time.

In general, scenes with overlapping objects and rough textures produce a better 3D effect than scenes with isolated objects and smooth surfaces. Terrain such as grass, brush and gravel produce a good 3D effect, as does a scene with a central plane of objects and lower foreground and higher background objects. Higher resolution displays also enhance the 3D effect: more detail can be rendered, which provides additional object details and texture references to the eye.

For scenes in which no net camera movement occurs (no camera pan), a non-moving plane of objects with a nearly constant distance to the camera can be set up in the scene: moving objects within this plane will have little net movement that results from the 3D effect, allowing the motion of objects within the plane to be viewed more easily. With arc-centered displacements, an object in the scene is chosen as the center point, which the camera will automatically track in computer-generated scenes.

In horizontal displacements, no object in the screen will be the exact same size, as the camera distance to all objects changes from one camera position to another. In arc-centered displacements, only the points along the axis at the arc center in the camera displacements will be the same distance to the camera. Objects near these points will be the same size from one camera position to another, and will also be nearly motion-free. All other points will have some motion as a result of the 3D effect, but a single x-z plane can be kept relatively motion-free. Positioning the camera further away from the scene (D>5×“C” in FIG. 14) will reduce object size differences from one view to another when the camera is moved to generate the 3D effect.

1. A method or apparatus for smoothing the appearance of auto-stereoscopic 3D presentations, as follows: more than 2 views of a scene are displayed in a sequence within a camera displacement waveform in time, such as a sinusoidal or triangle waveform, such that the waveform repeats at a rate of approximately 3 to 5 Hz, producing a 3D effect for the viewer without the use of special glasses or screens, providing smoother 3D presentations.

2. A method or apparatus of claim 1, wherein said 3D effect is produced while moving the camera or set of cameras in an arc centered on an object in the scene or linearly along one axis, that uses formulas for sine wave and triangle wave camera displacements as follows:
$$Y = A sin ( \frac{2 π ( N - 1 )}{FR / SF} )$$
$$Y = A ( \frac{2}{π} ) arcsin ( sin ( \frac{2 π ( N - 1 )}{FR / SF} ) )$$
Where Y=Camera Displacement
A=Amplitude (adjusted empirically for every scene)
FR=Frame Rate
SF=Switching Frequency
N=Frame Number, starting with 1

3. A method or apparatus of claims 1 and 2, wherein said 3D effect is produced while moving the camera or set of cameras in an arc centered on an object in the scene or linearly along one axis, cancelling the sinusoidal or triangle waveform displacements in one direction, and exaggerating the displacements in the other direction, producing a net camera movement (pan). A formula that accomplishes this effect is as follows:
$$Y = A ( sin ( \frac{2 π ( N - 1 )}{FR / SF} ) + ( \frac{2 π ( N - 1 )}{FR / SF} ) )$$
Where Y=Camera Displacement
A=Amplitude (adjusted empirically for every scene)
FR=Frame Rate
SF=Switching Frequency
N=Frame Number, starting with 1

4. A method or apparatus of claims 1, 2 and 3, wherein said 3D effect is produced by keeping an entire plane in a scene stationary, with respect to the motion caused by the periodic camera displacements (objects within the plane can move independently of camera movement), while other planes move relative to the stationary plane.

5. A method or apparatus of claims 1, 2 and 3, wherein said 3D effect is produced by keeping central characters or objects stationary, with respect to the motion caused by the periodic camera displacements (characters and objects within the plane can move independently of camera movement), while the scene shifts or rotates along all six degrees of freedom (up/down, forward/backward, left/right, yaw, pitch, roll).

6. A method or apparatus of claims 1, 2, 3, 4, and 5, wherein said 3D effect is produced by using the following formula for camera displacement amplitude:
$$A = Z \frac{{D}^{2} X}{2 Cf}$$
$$Or$$
$$Ar = arctan ( Z \frac{DX}{2 Cf} )$$
Where A=displacement amplitude in linear coordinates
Ar=displacement amplitude in radians
D=distance from camera to stationary object or plane in the scene
C=distance from stationary object or plane to object closest to the camera
Z=apparent motion constant, −0.002
X=camera horizontal image dimension
f=camera focal length

7. A method or apparatus of claims 1, 2, 3, 4, 5 and 6, wherein said 3D effect is produced by using pre-rendered scenes for applications where a net camera movement does not occur, rendering only moving objects within the scene from one frame to the next, thereby reducing processing requirements.

8. A method or apparatus of claims 1, 2, 3, 4, 5, 6, and 7, wherein said 3D effect is produced by using computer algorithms or manual methods to generate two or more distinct views of a scene from a single view.

9. A method or apparatus of claims 1, 2, 3, 4, 5, 6, 7, and 8, wherein said 3D effect is generated by computer algorithms or electronic switches for immediate viewing, or stored for later viewing.

10. A method or apparatus of claims 1, 2, 3, 4, 5, 6, 7, and 8, wherein said 3D effect is generated by computer algorithms or electronic switches for use in a video game, where the game is played on a computer desktop, laptop, tablet, arcade machine, smart phone, dedicated console, handheld gaming device or online website.

11. A method or apparatus of claims 1, 2, 3, 4, 5, 6, 7, and 8, wherein said 3D effect is generated by computer algorithms or electronic switches for use in still images, webpages, movies, television programs, electronic books and magazines, and internet or other video formats.
